(19) United States
(12) Patent Application Publication
(10) Pub. No.: US 2017/0032199 A1
(43) Pub. Date: Feb. 2, 2017

(54) VIDEO DATA ANALYZING METHOD AND APPARATUS AND PARKING LOT MONITORING SYSTEM

(71) Applicant: FUJITSU LIMITED, Kawasaki-shi (JP)

(72) Inventors: Qi WANG, Beijing (CN); Guocheng Zhang, Beijing (CN); Zhiming Tan, Beijing (CN)

(73) Assignee: FUJITSU LIMITED, Kawasaki-shi (JP)

(21) Appl. No.: 15/222,284

(22) Filed: Jul. 28, 2016

(30) Foreign Application Priority Data
Jul. 31, 2015 (CN) 201510463583.6

(51) Int. Cl. G06K 9/00; H04N 7/18; G08G 1/14; G06K 9/46; G06T 7/00; H04L 29/06; G06K 9/62

(52) U.S. Cl. CPC G06K 9/00812; H04L 67/42; H04N 7/185; G06K 9/6267; G06K 9/46; G06T 7/0079; G08G 1/143; G06K 2009/4666; G06T 2207/20021; G06T 2207/30252

(57) ABSTRACT

This application provides a video data analyzing method and apparatus and a parking lot monitoring system where the system includes: a video camera configured to capture videos; a data memory configured to store video data from the video camera; an analysis server configured to analyze a status of each parking lot according to the video data obtained from the data memory; an information publishing device configured to publish status information on each parking lot; and a central manage system configured to control operations of parts of the parking lot monitoring system. With the method, apparatus or system of this application, a large quantity of parking lots may be monitored by using few hardware resources, and high detection precision under an all-weather condition may be realized, which is extendable, and may support high-grade functions based on core technologies.

### CROSS-REFERENCE TO RELATED APPLICATIONS

This application claims the priority benefit of Chinese Patent Application No. 201510463583.6, filed on Jul. 31, 2015 in the Chinese State Intellectual Property Office, the disclosure of which is incorporated herein in its entirety by reference.

### BACKGROUND

1. Field

The present disclosure relates to the field of image processing technologies and, in particular, to a video data analyzing method and apparatus and a vehicle parking lot monitoring system.

2. Description of the Related Art

As the number of private vehicles increases rapidly in recent years, parking has become a serious problem for both drivers and the government. For drivers, it usually takes a long time to find a valid parking lot; for authorities, the statistical information on public and chargeable parking lots will help to relieve the problem and make for better planning. What's more, an intelligent parking monitoring system will report the status change of each parking lot over the time, hence assist the administrator to manage the parking site better.

There are already a number of solutions provided for stated parking guidance system. Generally, they are classified as sensor-based solutions and camera-based solutions. The sensor-based solutions are most widely adopted due to low cost. However, detection precision is not sufficient enough for parking status monitoring, as well as being limited by environment conditions. For example, systems that utilize an induction coil are interfered with by severe weather (e.g. lightening) and neighboring sensors; and systems that utilize ultra-sound sensors are not suitable for outdoor implementation. Camera-based solutions are promising due to the popularization of large scale video surveillance systems. Compared with sensor-based solutions, they provide more video information and make it possible to support advanced functions, such as plate number recognition. And there are different video analysis technologies used for the purpose of monitoring parking status.

Most camera-based solutions will use one customized camera to cover 2-3 parking lots, thus the entire system will be very expensive due to hardware cost, and not alone it is not suitable for outdoor implementation. To reduce system cost, some solutions are to evaluate the number of entering and exiting vehicles within a certain area instead, but the detailed status of each parking lot is not be provided.

It should be noted that the above description of the background is merely provided for clear and complete explanation of the present disclosure and for an easy understanding by those skilled in the art. And it should not be understood that the above technical solution is known to those skilled in the art as it is described in the background of the present disclosure

### SUMMARY

Additional aspects and/or advantages will be set forth in part in the description which follows and, in part, will be apparent from the description, or may be learned by practice of the invention.

In order to solve the problem pointed out in the Background, this application provides a video data analyzing method and apparatus and a parking lot monitoring system, so as to monitor a large quantity of parking lots by using few hardware resources, and realize high detection precision under an all-weather condition.

According to a first aspect of the embodiments of the present disclosure, there is provided a parking lot monitoring system, including:
a video camera configured to capture videos;
a data memory configured to store video data from the video camera;
an analysis server configured to analyze a status of each parking lot according to the video data obtained from the data memory;
an information publishing device configured to publish status information on each parking lot; and
a central manage system configured to control operations of parts of the parking lot monitoring system.

According to a second aspect of the embodiments of the present disclosure, there is provided a video data analyzing method, including:
extracting a patch of a parking lot in video data of a current frame;
judging whether a status of the parking lot changes according to the patch of the parking lot in the video data of the current frame and a patch of the parking lot in video data of a previous frame;
detecting whether a vehicle parks on the parking lot if the status of the parking lot changes, and determining a status of the parking lot according to a detection result; and
determining the status of the parking lot as a previous status if the status of the parking lot does not change.

According to a third aspect of the embodiments of the present disclosure, there is provided a video data analyzing apparatus, including:
a patch extracting unit configured to extract a patch of a parking lot in video data of a current frame;
a judging unit configured to judge whether a status of the parking lot changes according to the patch of the parking lot in the video data of the current frame and a patch of the parking lot in video data of a previous frame;
a vehicle detecting unit configured to detect whether a vehicle parks on the parking lot when it is judged by the judging unit that the status of the parking lot changes; and
a status determining unit configured to determine a status of the parking lot according to a judgment result of the judging unit and/or a detection result of the vehicle detecting unit.

An advantage of the embodiments of the present disclosure exists in that with the method, apparatus or system provided in this application, a large quantity of parking lots may be monitored by using few hardware resources, and high detection precision under an all-weather condition may be realized, which is extendable, and may support high-grade functions based on core technologies.

With reference to the following description and drawings, the particular embodiments of the present disclosure are disclosed in detail, and the principle of the present disclosure and the manners of use are indicated. It should be understood that the scope of the embodiments of the present disclosure is not limited thereto. The embodiments of the present disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of the present disclosure, which constitute a part of the specification and illustrate the preferred embodiments of the present disclosure, and are used for setting forth the principles of the present disclosure together with the description. It is obvious that the accompanying drawings in the following description are some embodiments of the present disclosure only, and a person of ordinary skill in the art may obtain other accompanying drawings according to these accompanying drawings without making an inventive effort. In the drawings:

FIG. 1 is a schematic diagram of a structure of the parking lot monitoring system of an embodiment;

FIG. 2 is a schematic diagram of a deployment scenario of a video camera;

FIG. 3 is a schematic diagram of a structure of an analysis server of this embodiment;

FIG. 4 is a schematic diagram of a patch of a parking lot;

FIG. 5 is a schematic diagram of a detected target rectangle;

FIG. 6 is a schematic diagram of a polling mechanism of this embodiment;

FIG. 7 is a flowchart of the video data analyzing method of this embodiment; and

FIG. 8 is a schematic diagram of a structure of the computer system of this embodiment.

### DETAILED DESCRIPTION

Reference will now be made in detail to the embodiments, examples of which are illustrated in the accompanying drawings, wherein like reference numerals refer to the like elements throughout. The embodiments are described below to explain the present disclosure by referring to the figures.

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

### Embodiment 1

This application provides a parking lot monitoring system. FIG. 1 is a schematic diagram of a structure of the system. As shown in FIG. 1, the parking lot monitoring system 100 includes a video camera 101, a data memory 102, an analysis server 103, a central manage system 104 and an information publishing device 105.

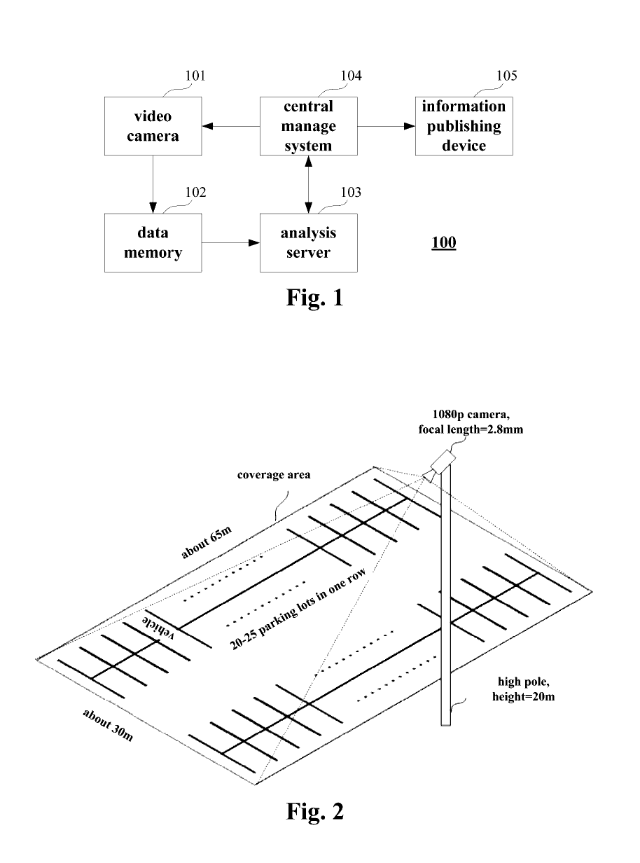

In this embodiment, the video camera 101 is configured to capture videos, so that the analysis server 103 analyzes a status of a parking lot according to the videos captured by the video camera 101. In this embodiment, a camera type and the number of the video camera 101 are not limited in this embodiment, and which type of video camera and how many video cameras are used depend on an application scenario, and a pan tilt zoom (PTZ) video camera, a bullet video camera, or other types of video cameras may be used. Furthermore, by considering the planning of a parking site where the system to be implemented and deploying video cameras with proper height and angle, optimal coverage efficiency may be achieved. In this embodiment, if a target scenario is an outdoor parking site (with no a roof) as shown in FIG. 2, and a video camera with illustrated specifications is deployed, one video camera can cover 80-100 parking lots, and for other cases where a relatively small area is covered, a height of an installed video camera will be correspondingly lowered. And if a target scenario is indoor or a parking site with a roof where a camera installment height is limited, such as 3 meters, one video camera can cover 6-8 parking lots.

In this embodiment, the data memory 102 is configured to store video data from the video camera 101, and provide the data to the analysis server 103 for further analysis and retrieve. Considering the convenience of system building, a network video recorder (NVR) may be used as the data memory 102. Of course, this embodiment is not limited thereto, and the data memory 102 may also be embedded in the camera 101, and provide data to the analysis server 103 via a camera network; or the data memory 102 may also be embedded in the analysis server 103 or in the central manage system 104.

In this embodiment, the analysis server 103 is configured to analyze a status of each parking lot according to the video data obtained from the data memory 102, and output an analysis result to the central manage system 104, a detailed analysis process is going to be described below. In this embodiment, in order to analyze the status of the parking lot, initialization needs to be performed on deployment of the parking site implementing the parking lot monitoring system 100 of this embodiment, including determining overall planning of the parking site, such as how many video cameras are deployed, a position of each video camera, which parking lots are covered by each video camera, a position of each parking lot, and coordinates of each parking lot, etc. By the initialization, deployment of the whole parking site may be defined, and information (coordinates) on each parking lot area may be obtained, so as to provide basis for the analysis server 103 for analyzing the videos captured by the video camera. After the deployment of the parking site is determined, only one time of initialization is needed, and initialization needs not to be repeated only if the deployment of the parking site is not changed. And the initialization may be performed in the analysis server 103, and may also be performed in the central manage system 104. For example, the initialization may be performed by a module added in the analysis server 103 or the central manage system 104; of course, this embodiment is not limited thereto.

In this embodiment, the central manage system 104 is a controller of the whole parking lot monitoring system 100, and is configured to control operations of parts of the parking lot monitoring system 100. It consists of central manage system (CMS) software and a hardware platform supporting the software, functions of the CMS including:
1) providing administration service and a graphical user interface (GUI) for control operations;
2) managing access to other devices, such as the video camera 101 and the data memory 102; and
3) controlling data storage, relay and information publishing, etc.

In this embodiment, the information publishing device 105 is configured to publish status information on each parking lot, so as to improve the convenience of both drivers and parking administrators. Typically, such kind of information may be published via a light-emitting diode (LED) poster at an entrance of the parking area, or may be updated via administration software or a website, and a smart mobile phone application is also a viable method. in this embodiment, functions of the information publishing device 105 may be integrated into the central manage system 104; however, this embodiment is not limited thereto.

In this embodiment, as the initialization is performed on the deployment of the parking site, the information on each parking lot may be obtained from the video data captured by the video camera, and the analysis server 103 determines the status of each parking lot by analyzing the video data of each parking lot.

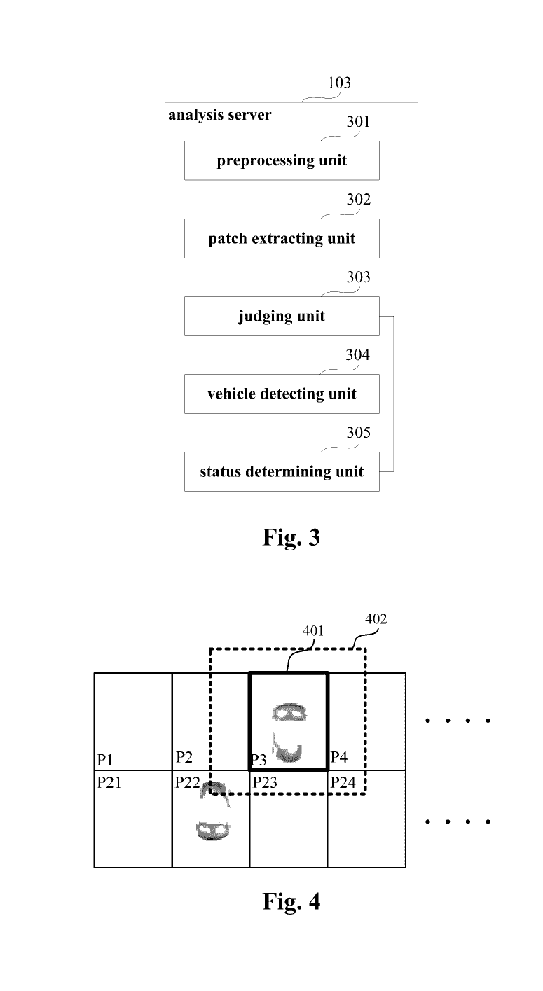

FIG. 3 is a schematic diagram of a structure of an implementation of the analysis server 103 of this embodiment. As shown in FIG. 3, in this implementation, the analysis server 103 includes: a preprocessing unit 301, a patch extracting unit 302, a judging unit 303, a vehicle detecting unit 304 and a status determining unit 305.

In this implementation, the preprocessing unit 301 is configured to perform image preprocessing on the video data of the current frame, such as noise reduction, and image enhancement, etc., for the convenience of subsequent analysis. On the premise that quality of the video camera is very high and resolution of the captured video data is also very high, the preprocessing unit 301 may be omitted.

In this implementation, a method of noise reduction includes but is not limited to the following two manners: one is a temporal filter, which calculates continuous frames to generate one representative frame Fᵣ to remove random image noises, only the representative frame being used for next operations; and the other one is a Gaussian filter, which operates on current frame to do smoothing. The related art may be referred to for a detailed process.

And in this implementation, a method of image enhancement includes but is not limited to a hue saturation value (HSV) equalizer, which helps to enhance image details under weak light conditions, such as rainy weather or nighttime. The related art may be referred to for a detailed process.

In this implementation, the patch extracting unit 302 is configured to extract a patch of the parking lot in video data of a current frame. The patch may be bigger than a parking space or parking slot.

In this implementation, the patch of the parking lot refers to an image area including a parking lot and its peripheral regions. As shown in FIG. 4, a patch of a parking lot P3 (area 401) is an area 402. Taking a case into account where a vehicle may possibly be parked in the middle of two parking lot spaces, resulting in irregular parking, an analyzing area in this embodiment is expanded around one parking lot space. It should be noted that, as described above, the information on each parking lot space area may be marked during initialization, or may be provided as a configuration file before the analysis process of the analysis server 103 starts.

Referring again to FIG. 4, assuming that image distortion caused by camera view angle is not taken into account, the parking lot area or space 401 to be processed is of a rectangle with a height H and a width W, and in order to obtain a corresponding patch (402), the patch (of the parking lot) extracting unit 302 of this embodiment may expand the original area 401 along a horizontal side and a vertical side. In an implementation, an expansion range in a horizontal direction is 0.4-0.8 time, preferably 0.5 times, of the width of the original area 401, and an expansion range in a vertical direction is 0.2-0.4 times, preferably 0.25 times, of the height of the original area 401. Taking that 0.5 time is expanded respectively in the horizontal direction and 0.25 time is expanded respectively in the vertical direction as an example, a length and a height of the expanded area 402 are respectively:

W_{patch}=W+W×0.5×2=2 W;

H_{patch}=H+H×0.25×2=1.5 H.

where W is width of the parking lot area or space 401, W_{patch} is patch width, H is height of the parking lot area or space 401, and H_{patch} is patch height.

For practical process, while the parking lot is shown as an irregular quadrilateral in the image, the same policy may also be used to acquire a patch area for processing, description of which being omitted herein.

In this implementation, the judging unit 303 is configured to judge whether the status of the parking lot changes according to the patch of the parking lot in the video data of the current frame and a patch of the parking lot in video data of a previous frame. In this implementation, the judging unit 303 may perform the above judgment by comparing the patch of the parking lot in the current representative frame and the patch of the parking lot in the previous representative frame. If it is judged yes, that is, an event or an action occurs at the parking lot, the vehicle detecting unit 304 may be used to detect whether a vehicle parks on the parking lot; otherwise, the step of vehicle detection may be jumped over and a status of the parking lot may be directly determined, thereby the redundant time-consuming vehicle detection operations may be avoided, an efficiency of the whole process may be improved, and frequent occurrence of such occupation status may be prevented.

In this implementation, a judgment method of the judging unit 303 may include but is not limited to an edge detection method. For example, a canny-like edge detector is used to generate an edge image of a patch of a parking lot that is to be processed, and if a difference between an edge image of the current frame and that of the previous frame is greater than a threshold TH_{change}, it is determined that the parking lot area changes.

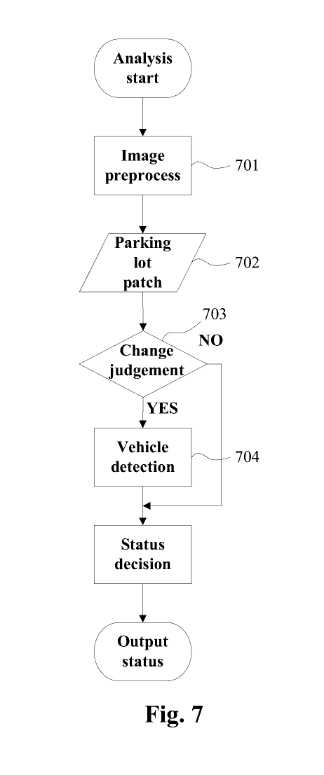

In this implementation, the current representative frame refers to the current frame, that is, a frame that is being currently processed, and the previous representative frame refers to a frame that was previously processed. It should be noted that as this embodiment is focused on a change of a status rather than tracking a whole process of an event, analysis on each frame of the video data is not high in efficiency. A part of frames of the video data are analyzed in this embodiment, the previous representative frame refers not to a previous frame of the current frame, but a frame that was previously processed before the current frame. As shown in FIG. 6, in this example, for video data captured by a video camera A, if a current frame is t₈, a previous frame is t₀, and the judging unit 303 judges whether the status of the parking lot changes according to patches of the parking lot in the video data of the two frames.

In this implementation, the vehicle detecting unit 304 is configured to detect whether a vehicle parks on the parking lot. In this implementation, the vehicle detecting unit 304 may detect the vehicle by using a feature detection method which is based on machine learning, including performing off-line training by using collected data set and performing on-line detection in a range of the patch of the parking lot. For such operations, an improving algorithm featured with a histogram of gradient (HoG) may be used; however, other features, such as a Harr-like feature, may also be used for such operations. And once a vehicle is detected, a target rectangle corresponding to the vehicle may be obtained.

In this implementation, the status determining unit 305 is configured to determine a status of the current parking lot according to a judgment result of the judging unit 303 and/or a detection result of the vehicle detecting unit 304, and provide the status to the central manage system 104. As described above, if it is judged by the judging unit 303 that the status of the current parking lot does not change, the status determining unit 305 determines that the status of the current parking lot as being the previous status, and if it is judged by the judging unit 303 that the status of the current parking lot changes and it is detected by the vehicle detecting unit 304 that no vehicle parks on the parking lot, the status determining unit 305 determines that the status of the current parking lot as being not occupied; otherwise, the status determining unit 305 determines the status of the current parking lot according to a relationship between the detected target rectangle corresponding to the vehicle and the area of the current parking lot.

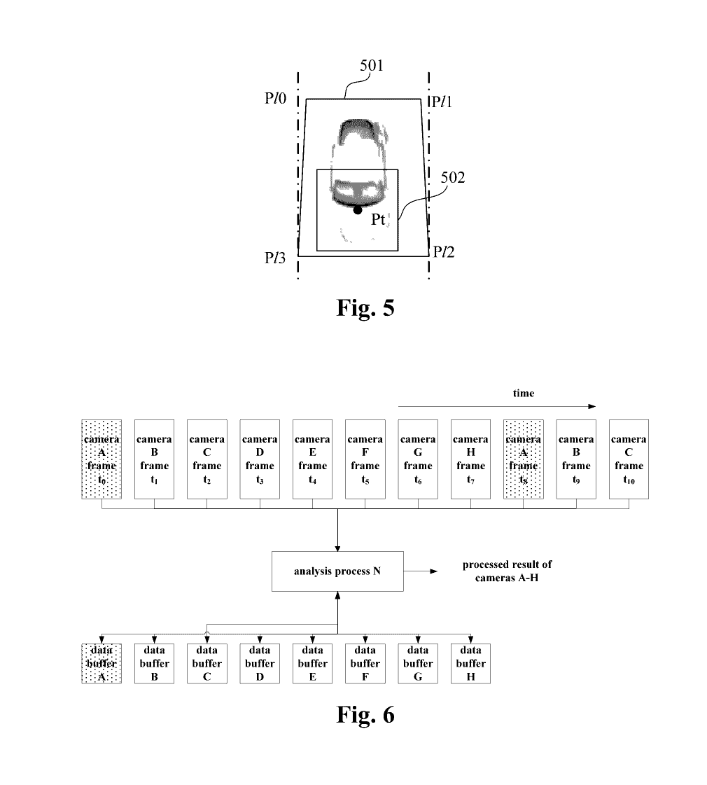

For example, if a ratio (Rveh) of a distance (Ldist) from a central point of the target rectangle to any side of the parking lot in a first direction to a length (Llot) of the parking lot in the first direction is greater than a first threshold, the status of the parking lot is determined as being normally occupied, otherwise, the status of the parking lot is determined as being illegally occupied. FIG. 5 is a schematic diagram of the target rectangle detected by the vehicle detecting unit 304. As shown in FIG. 5, assuming that Pl0-Pl3 are vertexes of a parking lot area 501 and Pt is a central point of a detected target rectangle 502, then

$${L}_{lot} = \vert Pl 2 \cdot x - Pl 3 \cdot x \vert , \\ {L}_{dist} = min ( \vert Pt \cdot x - Pl 2 \cdot x \vert , \vert Pt \cdot x - Pl 3 \cdot x \vert ) , \\ {R}_{velt} = \frac{{L}_{dist}}{{L}_{lot}} .$$

If Rᵥₑₕ is greater than a predetermined threshold TH_{warning} the status determining unit 305 determines that the status of the current parking lot as being normally occupied; otherwise, it shows that the vehicle is carelessly parked between two parking places or slots, and the status determining unit 305 determines that the status of the current parking space or slot as warning. And at this moment, the central manage system 104 may notify the administrator by sending a message. In this example, x denotes a horizontal coordinate direction.

With the analysis server of this embodiment, a status of each parking space may be determined, thereby avoiding redundant time-consuming vehicle detection operations, improving an efficiency of the analysis.

In this embodiment, an object of the parking lot monitoring system 100 is to analyze a status of a parking lot when an event of vehicle parking or vehicle leaving occurs. As this embodiment focuses on a change of a status rather than tracking a whole process of an event, when it is implemented as a commercial solution, analysis on data of each frame of the video stream of a video camera is inefficient. In this embodiment, a polling mechanism is proposed to assist the analysis server 103 in analyzing video streams of multiple video cameras.

In this embodiment, one analysis server 103 performs orderly or ordered analysis on video data captured by multiple video cameras in one analysis process using a temporal order, video data captured by each video camera being stored in the same buffer.

FIG. 6 is a schematic diagram of the polling mechanism of this embodiment. As shown in FIG. 6, data streams from 8 video cameras are sequentially analyzed, and some medium data that need to be referred to when processing a next frame of the same video camera will be stored in the same data buffer. For example, data of a video camera A will be stored in a data buffer A, data of a video camera B will be stored in a data buffer B, and so on. And processing delays between a frame tₙ and a frame tₙ₋₁ is equal to average delay for processing one frame.

Hence, assuming that N analysis processes are running simultaneously on an analysis server 103 and each analysis process handles video data from K video cameras, then an analysis server 103 works for N×K video cameras; wherein, both N and K depend on a hardware capacity of the server and the number of parking slots or spaces covered by one video camera.

With the parking lot monitoring system of this embodiment, a large quantity of parking lots may be monitored by using few hardware resources, and high detection precision under an all-weather condition may be realized, which is extendable, and may support high-grade functions based on core technologies, such as calculation of a parking time, warning of illegal parking, and classification of vehicle types, etc.

### Embodiment 2

This application further provides a video data analyzing method. As principles of the method for solving problems are similar to that of the analysis server 103 in Embodiment 1, the implementation of the analysis server 103 in Embodiment 1 may be referred to for implementation of the method, with identical contents being not going to be described any further.

FIG. 7 is a flowchart of the video data analyzing method of this embodiment. As shown in FIG. 7, the method includes:
step 702: a patch of a parking lot is extracted in video data of a current frame;
step 703: it is judged whether a status of the parking lot changes according to the patch of the parking lot in the video data of the current frame and a patch of the parking lot in video data of a previous frame; if it is judged yes, goes to step 704, otherwise determines that the status of the parking lot as being the previous status;
step 704: it is detected whether a vehicle parks on the parking lot, and a status of the parking lot is determined according to a detection result.

In step 704, if it is detected that no vehicle parks on the parking lot, it is determined that the status of the parking lot as being not occupied, and if it is detected that a vehicle parks on the parking lot, whether the status of the parking lot is being normally occupied or illegally occupied is determined according to a relationship between a target rectangle corresponding to the vehicle and an area of the parking lot.

In this embodiment, if a ratio of a distance from a central point of the target rectangle to any side of the parking lot in a first direction to a length of the parking lot in the first direction is greater than a first threshold, the status of the parking lot is determined as being normally occupied, otherwise, the status of the parking lot is determined as being illegally occupied.

In this embodiment, the method may further include:
step 701: image preprocessing is performed on the video data of the current frame; wherein, a method of the image preprocessing is as described above, and further description is omitted herein.

In this embodiment, a method of vehicle detection is not limited, and details are as described above. And when it is detected that a vehicle parks on the parking lot, the method further includes: acquiring a target rectangle corresponding to the vehicle.

With the method of this embodiment, a large quantity of parking lots may be monitored by using few hardware resources, and high detection precision under an all-weather condition may be realized, which is extendable, and may support high-grade functions based on core technologies, such as calculation of a parking time, warning of illegal parking, and classification of vehicle types, etc.

### Embodiment 3

This application further provides a video data analyzing apparatus. As principles of the apparatus for solving problems are similar to those of the analysis server 103 in Embodiment 1, the implementation of the analysis server 103 in Embodiment 1 may be referred to for implementation of the apparatus, with identical contents being not going to be described any further.

With the method of this embodiment, a large quantity of parking slots or spaces may be monitored by using few hardware resources, and high detection precision under an all-weather condition may be realized, which is extendable, and may support high-grade functions based on core technologies, such as calculation of a parking time, warning of illegal parking, and classification of vehicle types, etc.

### Embodiment 4

An embodiment of the present disclosure further provides a computer system, including the video data analyzing apparatus described in Embodiment 3, and the video data analyzing apparatus may be carried out by the analysis server 103 in Embodiment 1. As the analysis server 103 has been described in detail in Embodiment 1, the contents of which are incorporated herein, and shall not be described herein any further.

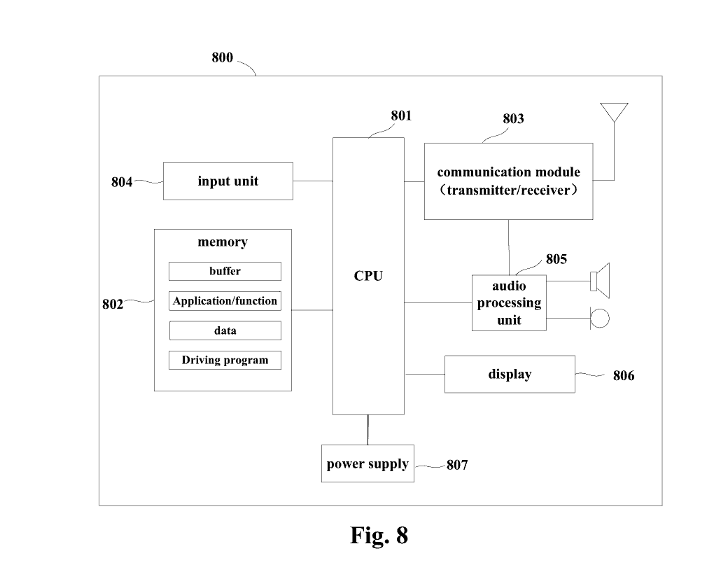

FIG. 8 is a schematic diagram of a hardware structure of the computer system of this embodiment. As shown in FIG. 8, the computer system 800 may include a central processing unit (CPU) 801 and a memory 802, the memory 802 being coupled to the central processing unit 801. It should be noted that this figure is illustrative only, and other types of structures may also be used, so as to supplement or replace this structure and achieve telecommunications function or other functions.

In an implementation, the functions of the analysis server 103 described in Embodiment 1 may be integrated into the central processing unit 801.

In another implementation, the analysis server 103 described in Embodiment 1 and the central processing unit 801 may be configured separately. For example, the analysis server 103 may be configured as a chip connected to the central processing unit 801, with its functions being realized under control of the central processing unit 801.

As shown in FIG. 8, the computer system 800 may further include a communication module 803, an input unit 804, an audio processing unit 805, a display 806, and a power supply 807. It should be noted that the computer system 800 does not necessarily include all the parts shown in FIG. 8. And furthermore, the computer system 800 may include components not shown in FIG. 8, and to which the related art may be referred.

As shown in FIG. 8, the central processing unit 801 is sometimes referred to as a controller or control, and may include a microprocessor or other processor devices and/or logic devices. The central processing unit 801 receives input and controls operations of every components of the computer system 800.

In this embodiment, the memory 802 may be, for example, one or more of a buffer memory, a flash memory, a hard drive, a mobile medium, a volatile memory, a nonvolatile memory, or other suitable devices. The memory 802 may store predefined or preconfigured information, video data captured by a video camera, and may further store programs executing related information. And the central processing unit 801 may execute the programs stored in the memory 802, so as to realize information storage or processing, etc. Functions of other parts are similar to those of the related art, which shall not be described herein any further. The parts of the computer system 800 may be realized by specific hardware, firmware, software, or any combination thereof, without departing from the scope of the present disclosure.

In this embodiment, the functions of the data memory 102 and the functions of the data buffer of Embodiment 1 may be integrated into the memory 802, and the functions of the central manage system 104 and the functions of the information publishing device 105 may be integrated into the central processing unit 801.

With the computer system 800 of this embodiment, a large quantity of parking slots may be monitored by using few hardware resources, and high detection precision under an all-weather condition may be realized, which is extendable, and may support high-grade functions based on core technologies, such as calculation of a parking time, warning of illegal parking, and classification of vehicle types, etc.

An embodiment of the present disclosure further provides a computer-readable program, wherein when the program is executed in a computer, the program enables the computer to carry out the method as described in Embodiment 2.

An embodiment of the present disclosure further provides a non-transitory storage medium in which a computer-readable program is stored, wherein the computer-readable program enables a computer to carry out the method as described in Embodiment 2.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a non-transitory storage medium for storing the above program, such as a hard disk, a floppy disk, a CD, a DVD, and a flash memory, etc.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

Although a few embodiments have been shown and described, it would be appreciated by those skilled in the art that changes may be made in these embodiments without departing from the principles and spirit of the disclosure, the scope of which is defined in the claims and their equivalents.

What is claimed is:

1. A vehicle parking lot monitoring system, comprising:
a video camera configured to capture videos;
a data memory configured to store video data from the video camera;
an analysis server configured to analyze a status of each parking lot according to the video data obtained from the data memory;
an information publishing device configured to publish status information on each parking lot; and
a central management system configured to control operations of parts of the parking lot monitoring system.

2. The system according to claim 1, wherein the analysis server comprises:
a patch extracting unit configured to extract a patch of the parking lot in the video data of a current frame;
a judging unit configured to judge whether a patch status of the parking lot changes according to the patch of the parking lot in the video data of the current frame and the patch of the parking lot in the video data of a previous frame;
a vehicle detecting unit configured to detect whether a vehicle parks on the parking lot when it is judged by the judging unit that the patch status of the parking lot changes; and
a status determining unit configured to determine a lot status of the parking lot according to a judgment result of one of the judging unit and a detection result of the vehicle detecting unit.

3. The system according to claim 2, wherein the analysis server further comprises:
a preprocessing unit configured to perform image preprocessing on the video data of the current frame.

4. The system according to claim 2, wherein the vehicle detecting unit acquires a target rectangle corresponding to a vehicle when it is detected that the vehicle parks on the parking lot.

5. The system according to claim 4, wherein the status determining unit determines that the lot status of the parking lot as a previous status when it is judged by the judging unit that the lot status of the parking lot does not change, determines the lot status of the parking lot as being not occupied when it is judged by the judging unit that the patch status of the parking lot changes and it is detected by the vehicle detecting unit that no vehicle parks on the parking lot, and determines the lot status of the parking lot according to a relationship between the target rectangle corresponding to the vehicle and an area of the parking lot when it is judged by the judging unit that the patch status of the parking lot changes and it is detected by the vehicle detecting unit that the vehicle parks on the parking lot.

6. The system according to claim 5, wherein when a ratio of a distance from a central point of the target rectangle to any side of the parking lot in a first direction to a length of the parking lot in the first direction is greater than a first threshold value, the lot status of the parking lot is determined as being normally occupied, otherwise, the lot status of the parking lot is determined as being illegally occupied.

7. The system according to claim 1, wherein the analysis server performs an ordered analysis on video data captured by multiple video cameras in an analysis process having a temporal order, video data captured by each video camera being stored in one data buffer.

8. A video data analyzing method, comprising:
extracting a patch of a vehicle parking lot in video data of a current frame;
judging whether a patch status of the parking lot changes according to the patch of the parking lot in the video data of the current frame and the patch of the parking lot in video data of a previous frame;
detecting whether a vehicle parks on the parking lot when the patch status of the parking lot changes, and determining a lot status of the parking lot according to a detection result; and
determining the lot status of the parking lot as a previous status when the lot status of the parking lot does not change.

9. The method according to claim 8, wherein the determining the lot status of the parking lot according to a detection result comprises:
determining the lot status of the parking lot as being not occupied when no vehicle is detected on the parking lot; and
determine the lot status of the parking lot as being normally occupied or being illegally occupied according to a relationship between a target rectangle corresponding to a vehicle and an area of the parking lot when it is detected that the vehicle parks on the parking lot.

10. A video data analyzing apparatus, comprising:
a patch extracting unit configured to extract a patch of a vehicle parking lot in video data of a current frame;
a judging unit configured to judge whether a patch status of the parking lot changes according to the patch of the parking lot in the video data of the current frame and the patch of the parking lot in video data of a previous frame;
a vehicle detecting unit configured to detect whether a vehicle parks on the parking lot when it is judged by the judging unit that the patch status of the parking lot changes; and
a status determining unit configured to determine a lot status of the parking lot according to a judgment result of one of the judging unit and a detection result of the vehicle detecting unit.

11. A non-transitory computer readable storage medium storing a video data analyzing method, the method comprising:
extracting a patch of a vehicle parking lot in a current frame video data where the patch is at least a size of a parking space;
judging whether a patch status of the parking lot changes according to the patch of the parking lot in the video data of the current frame and the patch of the parking lot in video data of a previous frame; and
detecting whether a vehicle parks on the parking lot when the patch status of the parking lot changes, and determining a lot status of the parking lot according to a detection result.
